(19) United States
(12) Patent Application Publication
(10) Pub. No.: US 2019/0080141 A1
(43) Pub. Date: Mar. 14, 2019

(54) TEXTURE IDENTIFICATION DEVICE AND ELECTRONIC DEVICE

(71) Applicant: BOE TECHNOLOGY GROUP CO., LTD., Beijing (CN)

(72) Inventor: Jifeng TAN, Beijing (CN)

(21) Appl. No.: 15/743,354

(22) PCT Filed: Jul. 7, 2017
(86) PCT No.: PCT/CN17/92177

§ 371 Date: Jan. 10, 2018

(30) Foreign Application Priority Data
Sep. 6, 2016 (CN) 201610805136.9

(51) Int. Cl. G06K 9/00; G02F 1/1335

(52) U.S. Cl. CPC G06K 9/00046; G02F 1/133606; G02F 1/133605

(57) ABSTRACT

A texture identification device includes a first substrate and a backlight disposed opposite to each other. The first substrate is disposed on a light exiting side of the backlight. A surface of the first substrate facing away from the backlight is a texture acquiring surface. A plurality of photoelectric sensors is disposed on the first substrate. Wherein the backlight is configured to emit a collimated light, and the collimated light is emitted from the texture acquiring surface of the first substrate and then reflected by the texture to the photoelectric sensors.

### CROSS-REFERENCE TO RELATED APPLICATIONS

The present application is based on International Application No. PCT/CN2017/092177, filed on Jul. 7, 2017, which is based upon and claims priority to Chinese Patent Application 201610805136.9, titled “TEXTURE IDENTIFICATION DEVICE AND ELECTRONIC DEVICE”, filed Sep. 6, 2016, and the entire contents thereof are incorporated herein by reference.

### TECHNICAL FIELD

The present disclosure relates to the field of display technology, and more particularly, to a texture identification device and an electronic device.

### BACKGROUND

Texture identification devices and electronic devices are now widely used. High accuracy is required when fingerprint identification is carried out by a texture identification device. However, in an existing optical fingerprint identification device, the attenuation of the energy of the light reaching the fingerprint may affect the accuracy of fingerprint identification carried out by the fingerprint identification device.

There is an urgent need for a texture identification device and an electronic device that can improve the accuracy of fingerprint identification.

### SUMMARY

The present disclosure provides a texture identification device and an electronic device.

In one aspect, the present disclosure provides a texture identification device, comprising: a first substrate and a backlight disposed opposite to each other, the first substrate being disposed on a light exiting side of the backlight, a surface of the first substrate facing away from the backlight being a texture acquiring surface, and a plurality of photoelectric sensors being disposed on the first substrate, wherein the backlight is configured to emit a collimated light, and the collimated light is emitted from the texture acquiring surface of the first substrate and then reflected by the texture to the photoelectric sensors.

Further, the backlight includes a plurality of collimated light sources.

Further, an orthogonal projection of a light sensor on the backlight is within an area of a collimated light source.

Further, a ratio of an orthogonal projection area of each photoelectric sensor on the backlight to an area of the collimated light source is 1/2.

Further, the backlight comprises a transparent medium layer, a light emitting unit is disposed on a side of the transparent medium layer adjacent to the first substrate, and a reflection layer is disposed on a side of the transparent medium layer away from the first substrate;

wherein a plurality of arc-shaped protrusions bonded to the reflection layer is disposed on a side of the transparent medium layer facing the reflection layer, and each of the arc-shaped protrusions corresponds to one light emitting unit.

Further, the light emitting unit comprises an organic light emitting diode, and a light source reflection layer is disposed on a side of the organic light emitting diode adjacent to the first substrate; wherein light emitted by the organic light emitting diode is emitted along a side away from the first substrate.

Further, the light emitting unit comprises an organic light emitting diode, and light emitted by the organic light emitting diode is emitted along a side away from the first substrate, wherein the backlight further comprises a transparent second substrate for carrying the light emitting unit, and the second substrate is disposed on a side of the light emitting unit adjacent to the first substrate.

Further, the collimated light source comprises a third substrate, a reflection layer is disposed on a side of the third substrate adjacent to the first substrate, a plurality of arc-shaped grooves is disposed in the reflection layer, and a light emitting unit is disposed on a side of each of the arc-shaped grooves adjacent to the first substrate, and transparent material is filled between the light emitting unit and the arc-shaped groove to form a transparent medium layer.

Further, a surface of the arc-shaped protrusion is a spherical cap in shape, and a spherical radius corresponding to the spherical cap is larger than a distance between the light emitting unit and a section where an apex of the spherical cap is located.

Further, a surface of the arc-shaped groove is a spherical cap in shape, and a spherical radius corresponding to the spherical cap is larger than a distance between the light emitting unit and a section where an apex of the spherical cap is located.

Further, the collimated light source is a monochromatic collimating light source or a white light collimating light source.

Further, a light shielding unit is disposed on a side of each photoelectric sensor adjacent to the backlight.

In another aspect, the present disclosure provides an electronic device, comprising the texture identification device according to any of the above.

Further, the texture identification device comprises a first substrate and a backlight disposed opposite to each other, and a plurality of photoelectric sensors being disposed on the first substrate, wherein the first substrate is a color filter substrate of the electronic device, and the plurality of photoelectric sensors is disposed on a side of the first substrate adjacent to the backlight; or the plurality of photoelectric sensors is disposed on a side of the first substrate away from the backlight.

### BRIEF DESCRIPTION OF THE DRAWINGS

FIG. 1 is a schematic structural diagram of an optical fingerprint identification device in the related art;

FIG. 2 is a schematic structural diagram of a texture identification device according to an embodiment of the present disclosure;

FIG. 3 is a top view of a collimated light source according to an embodiment of the present disclosure;

FIG. 4 illustrates simulation results of light quantities of the texture identification device having collimated light sources and a conventional texture identification device;

FIG. 5 is a top view of a texture identification device according to an embodiment of the present disclosure;

FIG. 6 illustrates a schematic diagram of simulation result of a difference between light intensities reflected by the valley and the ridge;

FIG. 7 is a first schematic structural diagram of a collimated light source according to an embodiment of the present disclosure;

FIG. 8 is a second schematic structural diagram of a collimated light source according to an embodiment of the present disclosure;

FIG. 9 is a schematic diagram of imaging principle of a spherical mirror;

FIG. 10 is a third schematic structural diagram of a collimated light source according to an embodiment of the present disclosure;

FIG. 11 is a schematic structural diagram of a backlight according to an embodiment of the present disclosure;

FIG. 12 is a schematic structural diagram of a monochromatic collimated light source and a white light collimated light source according to an embodiment of the present disclosure;

FIG. 13 is a first schematic structural diagram of a liquid crystal display panel according to an embodiment of the present disclosure; and

FIG. 14 is a second schematic structural diagram of a liquid crystal display panel according to an embodiment of the present disclosure.

### DETAILED DESCRIPTION

The technical solutions in the embodiments of the present disclosure will be clearly and completely described below with reference to the accompanying drawings of the embodiments of the present disclosure. Apparently, the described embodiments are merely a part but not all the embodiments of the present disclosure.

In addition, the terms “first” and “second” are used for descriptive purposes only and are not to be construed as indicating or implying relative importance or implied reference to the number of indicated technical features. Thus, features defined by “first” and “second” may explicitly or implicitly include one or more of the features. In the description of the present disclosure, “a plurality of” means two or more unless otherwise specified.

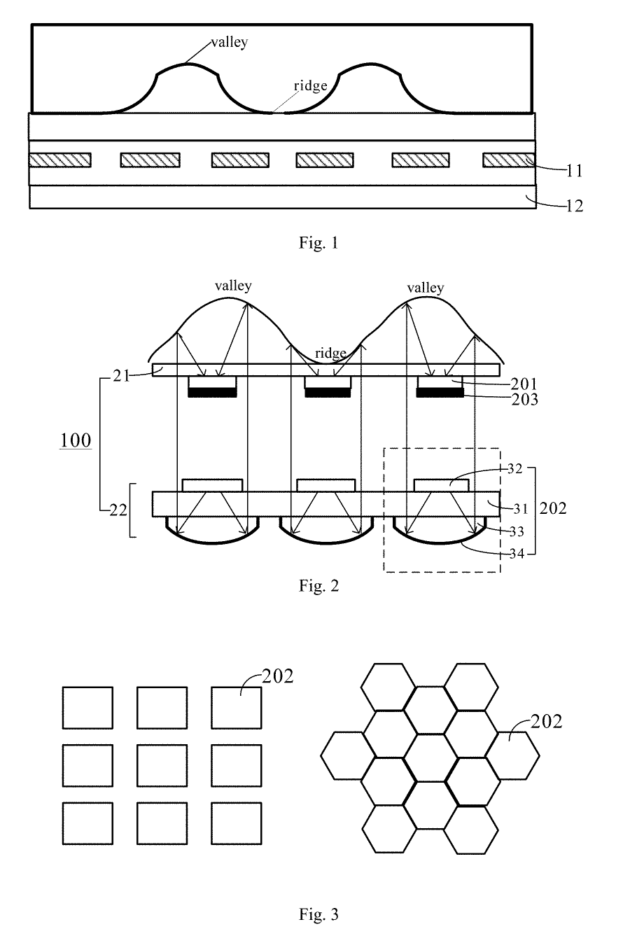

As shown in FIG. 1, an optical fingerprint identification device is typically provided with a plurality of photoelectric sensors 11, such as photodiodes and phototransistors. A backlight 12 is a surface light source. Light emitted from the backlight 12 is radiated to a finger and then diffused, and a part of the light is received by the photoelectric sensor 11. The photoelectric sensor 11 converts the received optical signal into a corresponding electric signal. Light will be reflected when passing through the troughs (hereinafter referred to as the valleys) and the peaks (hereinafter referred to as the ridges) of the fingerprints, and the light energy of the reflected light will be different. Generally, the light energy of the light reflected by the valleys is lower than the light energy of the light reflected by the ridges. Fingerprinting identification may be performed based on such difference.

Generally, the light emitted by the backlight 12 is divergent. That is, two originally adjacent light beams may be farther and farther apart in propagation. In this case, the light propagation path is not controllable, and the light emitted from the backlight 12 may reach the fingerprint after being diffused and reflected for multiple times, with the energy of the light significantly attenuated. When the energy of the light is lower than a sensing lower limit value of the photoelectric sensor 11, the photoelectric sensor 11 may fail to sense the received light signal, and in turn, fail to determine the relative positions of the valleys and ridges, thus affecting the accuracy of fingerprinting fingerprint identification device.

In view of this, the present disclosure provides a texture identification device, including a first substrate and a backlight disposed opposite to each other. The first substrate is disposed on the light exiting side of the backlight. The surface of the first substrate facing away from the backlight is a texture acquiring surface. The backlight is configured to emit a collimated light. A plurality of photoelectric sensors is disposed on the first substrate. The photoelectric sensor is configured to receive the reflected light of the collimated light passing through the texture acquiring surface.

The first substrate is a carrier substrate carrying the plurality of photoelectric sensors. That is, the plurality of photoelectric sensors may be disposed on a side of the first substrate adjacent to the backlight, or may be disposed on a side of the first substrate facing away from the backlight, which is not limited in this embodiment of the present disclosure.

In addition, the texture identification device can be used to identify fingerprints or any object having a fingerprint. The embodiments of the present disclosure do not make any limitation to this. For the convenience of illustration of the operation principle of the texture identification device, the fingerprint identification will be described in detail later.

Specifically, since the collimated light emitted by the backlight is parallel light, the propagation path of the light can be controlled. Therefore, the collimated light can be directly irradiated to the fingerprints on the texture acquiring surface, to reduce the attenuation of light in the propagation process. In this way, after the reflection of the valleys and the ridges of the fingerprint, the optical signal of the reflected light can be sensed by the photoelectric sensor, so as to improve the accuracy of the fingerprint identification.

For example, as shown in FIG. 2, the present disclosure provides a texture identification device 100. The texture identification device 100 includes a first substrate 21 and a backlight 22 opposite to each other.

The backlight 22 includes a plurality of collimated light sources 202. A plurality of photoelectric sensors 201 is disposed on the first substrate 21.

For example, taking the collimated light source 202 as an example, as shown in FIG. 3, the plurality of collimated light sources 202 may be arranged in an array (as shown on the left in FIG. 3) or in a honeycomb (as shown on the left in FIG. 3), which will not be repeated in subsequent embodiments.

As shown in FIG. 2, since the light emitted by the collimated light source 202 is parallel light, the propagation path of the light from the backlight 22 to the fingerprints can be controlled, and the light can directly irradiate the fingerprint, so as to reduce the attenuation of light in the propagation process. In this way, after the reflection of the valleys and the ridges of the fingerprint, the optical signal of the reflected light can be sensed by the photoelectric sensor, so as to improve the accuracy of the fingerprint identification.

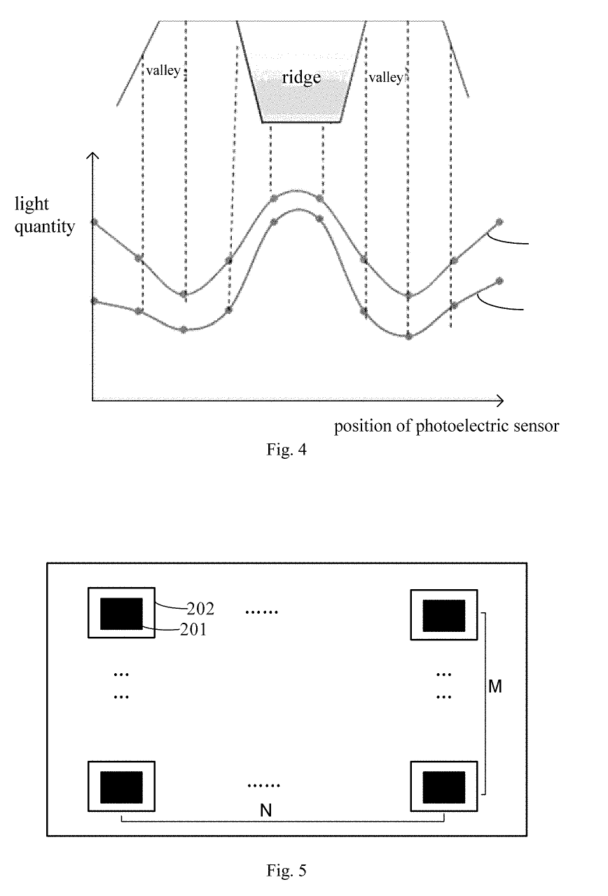

Specifically, FIG. 4 illustrates the simulation results of the light quantities of the texture identification device 100 having the collimated light sources 202 and a conventional texture identification device 100-1. It may be seen that for the 10 photoelectric sensors 201 with the same positions and the same fingerprint (i.e., valleys and ridges), when the texture identification device 100 having the collimated light sources 202 is used, the light quantities at the photoelectric sensors 201 are all higher than the light quantities of the conventional texture identification device, so as to ensure that the optical signal of the reflected light can be sensed by the photoelectric sensor, and improve the accuracy of the fingerprint identification.

Further, as shown in FIG. 2, an orthogonal projection of a light sensor 201 on the backlight is within an area of a collimated light source 202 of the backlight 22.

In this case, as shown in FIG. 5, which is a top view of the texture identification device 10, M*N photoelectric sensors 201 and M*N collimated light sources 202 are arranged in an array and correspond one to one. Assuming that a is an orthogonal projection area of each photoelectric sensor 201 on the backlight 22, b is a light emitting area of the corresponding collimated light source 202. In this case, a filling factor may be set as a/b.

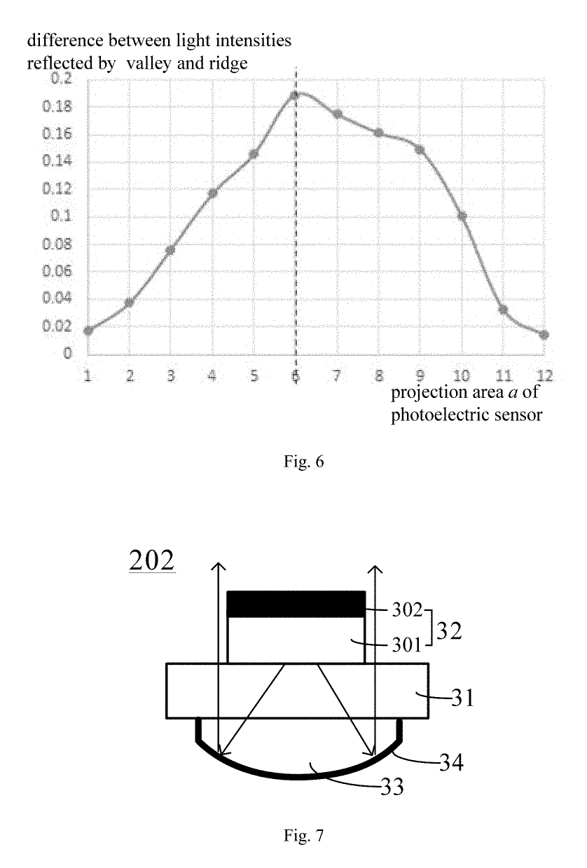

When the value of the filling factor changes, the difference between the light intensities reflected by the valley and the ridge, received by each photoelectric sensor 201, also changes. FIG. 6 illustrates a schematic diagram of the simulation result of the filling factor and the difference between the light intensities reflected by the valley and the ridge, in which the light emitting area b of the collimated light source 202 at a horizontal plane is a constant value b=12. The value of the filling factor may be changed by changing the value of a. As shown in FIG. 6, when a=6, that is, when the filling factor is 0.5, the difference between the light intensities reflected by the valley and the ridge received by the photoelectric sensor 201 is the largest, which is more accurate for determining the relative positions of the valley and the ridge and may improve the accuracy of the fingerprint identification.

In addition, as shown in FIG. 2 again, a light shielding unit 203 is disposed on a side of each photoelectric sensor 201 adjacent to the backlight 22. For example, the light shielding unit 203 may be a light shielding metal plate. The area of the light shielding unit 203 may be equal to or smaller than the orthogonal projection area of the photoelectric sensor 201 on the first substrate 21.

The light shielding unit 203 may block the light emitted by the collimated light source 202 directly to the photoelectric sensor 201, such that the corresponding photoelectric sensor 201 does not sense the light directly emitted by the collimated light source 202. Thus, the photoelectric sensor 201 receives only the light reflected by the fingerprint, so as to determine the relative positions of the valley and the ridge according to the light intensities of the light.

Specifically, as shown in FIG. 2, the backlight 22 may include a transparent medium layer 31. A plurality of light emitting units 32 is disposed on a side of the transparent medium layer 31 adjacent to the first substrate 21. A reflection layer 34 is disposed on a side of the transparent medium layer 31 facing away from the first substrate 21.

A plurality of arc-shaped protrusions 33 bonded to the reflection layer 34 are disposed on a side of the transparent medium layer 31 facing the reflection layer 34. Each of the arc-shaped protrusions 33 corresponds to one of the light emitting units 32.

For example, the embodiments of the present disclosure provide three solutions for the collimated light source 202 in the backlight 22, which will be described in detail below.

First Solution

As shown in FIG. 2 again, the light emitting units 32 are directly disposed on a side of the transparent medium layer 31 facing away from the reflection layer 34. In this case, each light emitting unit 32 can be regarded as a point light source. Light emitted by the light emitting unit 32 passes through the arc surface of the arc-shaped protrusions 33, and forms parallel light (i.e. the collimated light) after being reflected by the reflection layer 34. That is, the collimated light can be directly irradiated to the valley and ridge of the fingerprint. In this case, light shielding regions and light emitting regions are arranged alternately in the backlight 22, such that all the lights emitted from the light emitting region 32 exit from the light emitting regions after being reflected by the arc-shaped protrusions 33. Thus, it may avoid waste of light energy and may improve the light utilization efficiency of the texture identification device 100.

In this case, the light emitting unit 32 includes an OLED (Organic Light Emitting Diode). For example, as shown in FIG. 7, a schematic structural diagram of a collimated light source 202 is provided. The light emitting unit 32 includes an organic light emitting diode 301 disposed on the transparent medium layer 31 and a light source reflection layer 302 disposed on the organic light emitting diode 301. The light emitted by the organic light emitting diode 301 is emitted along a side away from the first substrate 21.

The light source reflection layer 302 reflects downward the light emitted upward from the organic light emitting diode 301 such that the light emitted by the organic light emitting diode 301 is directed toward the arc-shaped protrusion 33. For example, the light source reflection layer 302 may be a high-reflectance film layer. Alternatively, the light source reflection layer 302 may further include a scattering layer and an absorption layer disposed opposite to each other. The absorption layer is adjacent to the first substrate 21. The scattering layer is configured to scatter the light emitted from the organic light emitting diode 301 upward. Finally, the part of light that has been scattered is absorbed by the absorption layer, and only the light emitted downward by the organic light emitting diode 301 remains, such that the light emitted by the organic light emitting diode 301 is emitted along a side away from the first substrate 21.

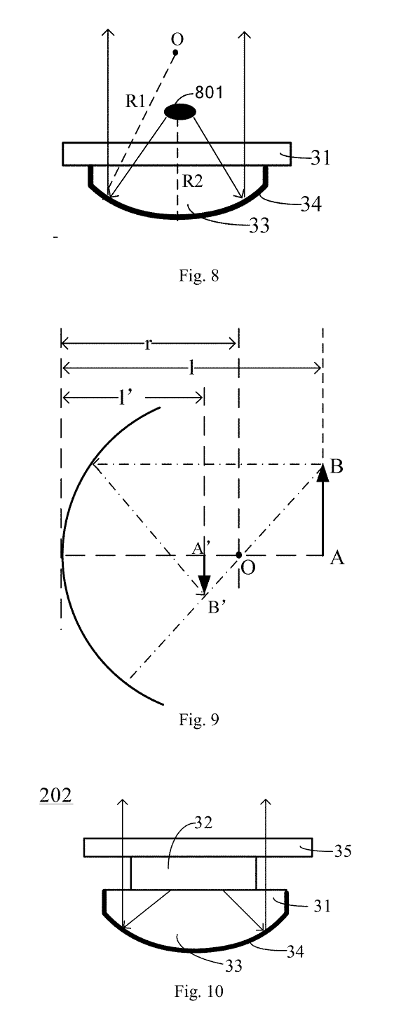

Specifically, the surface of the arc-shaped protrusion 33 is a spherical cap in shape. After the light emitted from the organic light emitting diode 301 is irradiated to the arc-shaped protrusion 33 and the reflection layer 34, collimated light may be formed based on the spherical mirror imaging principle. As shown in FIG. 8, the spherical radius corresponding to the spherical cap is R1, the organic light emitting diode 301 can be regarded as a light emitting point 801, and the distance between the light emitting point and the spherical cap is R2. When R1>R2, the arc-shaped protrusion 33 may have the effect of collimating the incident light. In one embodiment, R1=2R2 can be set.

Specifically, as shown in FIG. 9, a schematic diagram illustrating the imaging principle of a spherical mirror is shown. The image of AB is A′B′, r is the radius of the sphere where the spherical surface is located, l is the object distance, and l′ is the image distance. In this case, the imaging formula of spherical mirror can be expressed as: Error! Objects cannot be created from editing field codes.

Then, when l′ tends to infinity (the image distance tends to infinity), that is, the object is represented at infinity, then the light reflected by the spherical surface is approximated as parallel light. At this time, the imaging formula of spherical mirror becomes: Error! Objects cannot be created from editing field codes, i.e. r=2l. In the present solution, l is the distance R2 between the organic light emitting diode 301 and the section where the apex of the spherical cap is located, and r is the spherical radius R1 corresponding to the spherical cap formed by the arc-shaped protrusion 33. Therefore, when R1=2R2, the arc-shaped protrusion 33 will have the effect of completely collimating the incident light.

Second Solution

As shown in FIG. 10, which is a schematic diagram of a collimated light source 202, the backlight 22 further includes a transparent second substrate 35 for carrying the light emitting unit 32. The second substrate 35 is disposed on a side of the light emitting unit 32 adjacent to the first substrate 21.

In this case, the formation principle of the collimated light source 202 is similar to that of the first solution, so the details are not repeated again.

Different from the first solution, in this case, the light emitting unit 32 may simply be an organic light emitting diode. Light emitted by the organic light emitting diode is also emitted along a side away from the first substrate 21, and no reflection layer needs to be disposed on the organic light emitting diode to change the light exiting direction of the organic light emitting diode. Therefore, the structure of the collimated light source 202 in the second solution is simpler.

In the first solution and the second solution, the material of the transparent medium layer 31 may be a transparent organic material, such as a transparent polymer material such as polymethylmethacrylate (PMMA), a resin, and the like, which may be specifically manufactured through a MASK mapping process, embossing process, laser direct writing process, or electron beam directing process to make the arc-shaped protrusion 33. This is not limited in this embodiment of the present disclosure. After the arc-shaped protrusions 33 are formed, a reflection-type metal is deposited on the surface of the arc-shaped protrusions 33 by vapor deposition to form the reflection layer 34. For example, silver or aluminum may be used as the reflection-type metal. The thickness of the reflection layer 34 is greater than 400 A (Angstroms).

Further, in order to prevent the reflective metal in the reflection layer 34 from being oxidized, a protective layer may be deposited on the reflection layer 34, which may be made of silicon nitride (Si3N4).

Third Solution

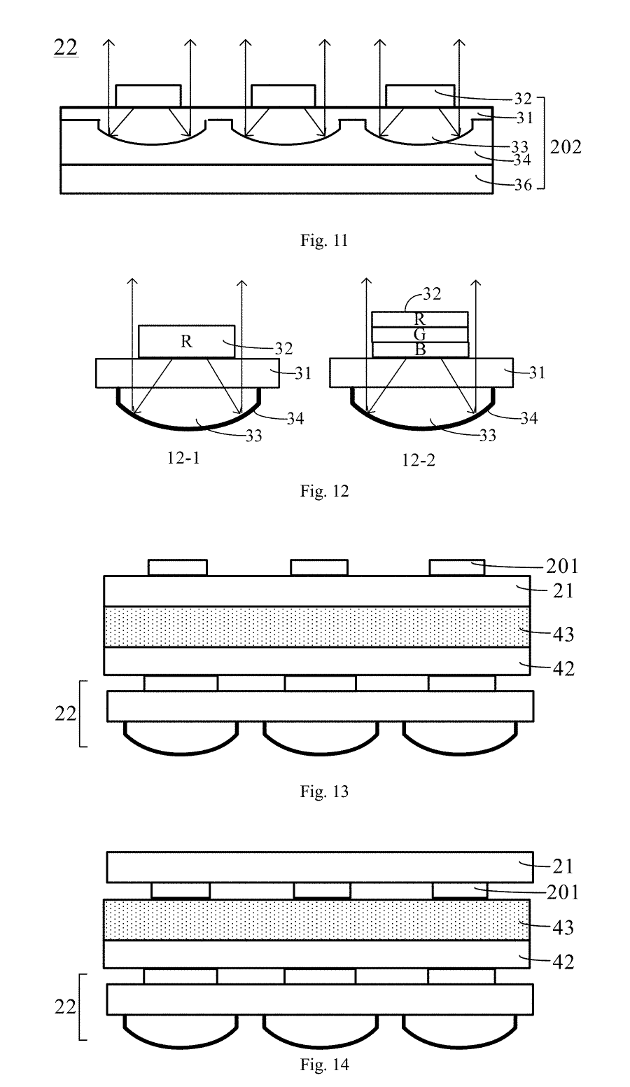

As shown in FIG. 11, in this case, the backlight 22 includes a third substrate 36. A reflection layer 34 is disposed on a side of the third substrate 36 adjacent to the first substrate 21. A plurality of arc-shaped grooves is disposed in the reflection layer 34. A light emitting unit 32 is disposed on a side of each arc-shaped groove adjacent to the first substrate 21. Transparent material is filled between the light emitting unit 32 and the arc-shaped groove to form a transparent medium layer 31.

It can be seen that, in contrast with the backlight 22 in the first solution or the second solution, in the third solution, the reflection layer 34 is disposed on the third substrate 36, the arc-shaped groove is provided and the arc-shaped groove is filled with transparent material to form the transparent medium layer 31 with arc-shaped protrusions 33. The principle of forming the collimated light is similar to that of the first embodiment, so the details are not repeated again.

Similar to the first solution and the second solution, in the third solution, the transparent medium layer 31 may be a transparent organic material. The reflection layer 34 is configured to receive and reflect the light emitted by the light emitting unit 32 to form collimated light. For example, the reflection layer 34 in FIG. 11 may be made of the above reflective metal, such as silver or aluminum. Alternatively, the reflective metal may be deposited on only the surface of the reflection layer 34 provided with the arc-shaped grooves. This is not limited in the embodiment of the present disclosure.

It should be noted that in the collimated light sources 202 with different structures provided in the first to the third solutions, the light emitting units 32 may be provided as point light sources such as LEDs instead of the organic light emitting diodes, which is not limited in this embodiment of the present disclosure.

Since when the light emitting unit 32 includes an organic light emitting diode, the organic light emitting diode can also be used for display, the backlight 22 can not only provide the backlight for the texture identification device 100 but also can perform the display function in the texture identification device 100 as a display unit.

In this case, each of the collimated light sources 202 in the backlight 22 can realize a display function as one sub-pixel unit. At the same time, the collimated light sources 202 can also provide backlight for the photoelectric sensors 201 on the first substrate 21 such that the photoelectric sensors 201 can receive the light reflected by the fingerprint, so as to implement the fingerprint recognition function. However, those skilled in the art can set the position and size relationship between the collimated light sources 202 and the photoelectric sensors 201 according to actual experience or algorithm. This is not limited in the embodiment of the present disclosure.

In addition, as shown in FIG. 12, the collimating light sources 202 with different structures provided in the first to third solutions may be the monochromatic collimating light sources 12-1 or the white light collimating light sources 12-2. For example, when the light emitting unit 32 includes an organic light emitting diode, when the collimated light source 202 is a monochromatic collimated light source, the luminescent material in each organic light emitting diode may be any one of the three primary colors of red (R), green (G) and blue (B). For example, when the collimated light source 202 is a white light collimated light source, the luminescent material in each organic light emitting diode may be a superposition of three luminescent materials: red, green and blue luminescent. The three luminescent materials respectively emit three types of lights of red, green and blue, and the three types of lights combines to form white light.

In addition, an embodiment of the present disclosure further provides an electronic device, which includes any one of the above-mentioned texture identification devices 100. The electronic device may be a mobile phone, a tablet, a television, and other terminal. However, the electronic device may also be a device having fingerprint identification function such as access control in the security system and safe box, which is not limited in the embodiment of the present disclosure.

For example, as shown in FIG. 2, the texture identification device 100 includes a first substrate 21 and a backlight 22 opposite to each other. The first substrate 21 includes a plurality of photo sensors 201.

In this case, the first substrate 21 may be used as a color filter substrate in the electronic device. The plurality of photoelectric sensors 201 are disposed on a side of the color filter substrate (i.e., the first substrate 21) adjacent to the backlight 22, or is disposed on a side of the color filter substrate (i.e., the first substrate 21) away from the backlight 22.

For example, as shown in FIG. 13, a liquid crystal layer 43 is disposed between the color filter substrate (i.e., the first substrate 21) and the array substrate 42, and the color filter substrate and the array substrate 42 are assembled together to form a display panel. In this case, the photoelectric sensors 201 in the texture identification device 100 are disposed outside the liquid crystal cell of the liquid crystal display panel, that is, the plurality of photoelectric sensors 201 are disposed on a side of the color filter substrate far away from the backlight 22. In this case, the backlight 22 serves as the backlight for both of the texture identification device 10 and the liquid crystal display panel.

Alternatively, as shown in FIG. 14, the photoelectric sensors 201 in the texture identification device 100 may be disposed in the liquid crystal cell of the liquid crystal display panel (as shown in FIG. 14, the liquid crystal cell includes a color filter substrate, an array substrate 42 and a liquid crystal Layer 43). That is, the plurality of photoelectric sensors 201 is disposed on a side of the color filter substrate adjacent to the backlight 22. Similar to that shown in FIG. 13, the backlight 22 serves as the backlight for both of the texture identification device 10 and the liquid crystal display panel.

The reason why the photoelectric sensors 201 in the texture identification device 100 are integrated on the color filter substrate is that the distance between the color filter substrate and the fingerprint is shorter than the distance between the array substrate and the fingerprint. Therefore, the photoelectric sensors 201 receive the light reflected by the finger fingerprint has stronger energy, so as to ensure that the optical signal of the reflected light can be sensed by the photoelectric sensor, and improve the accuracy of the fingerprint identification.

However, the above-mentioned plurality of photoelectric sensors 201 are disposed on a side of the array substrate 42 adjacent to the backlight 22 or the plurality of photoelectric sensors 201 are disposed on a side of the array substrate 42 far from the backlight 22. This is not limited in the embodiment of the present disclosure.

The present disclosure provides a texture identification device and an electronic device, including a first substrate and a backlight disposed opposite to each other. The first substrate is disposed on the light exiting side of the backlight. A surface of the first substrate facing away from the backlight is the texture acquiring surface. The first substrate is provided with a plurality of photoelectric sensors. The backlight is configured to emit collimated light. The collimated light exits from the texture acquiring surface. The photoelectric sensor is configured to receive the collimated light reflected by the texture. Since the collimated light emitted from the backlight is parallel light, and the propagation path of the light can be controlled, the collimated light can directly irradiate the texture to be identified to reduce the attenuation of the light during propagation. In this way, after the reflection of the texture to be identified, the optical signal of the reflected light can be sensed by the photoelectric sensor, so as to improve the accuracy of the fingerprint identification.

In the description of the present specification, a particular feature, structure, material, or characteristic may be combined in any suitable manner in any one or more of the embodiments or examples.

The foregoing descriptions are merely specific embodiments of the present disclosure, but the protection scope of the present disclosure is not limited thereto. Modifications and substitutions within the technical scope disclosed in the present disclosure easily conceived by one skilled in the art should be covered by the scope of the present disclosure. Therefore, the protection scope of the present disclosure should be subject to the protection scope of the claims.

1. A texture identification device, comprising:
a first substrate and a backlight, disposed opposite to each other, wherein the first substrate is disposed on a light exiting side of the backlight, a surface of the first substrate facing away from the backlight is a texture acquiring surface, and
a plurality of photoelectric sensors, disposed on the first substrate,
wherein the backlight is configured to emit a collimated light, and the collimated light is emitted from the texture acquiring surface of the first substrate, and is reflected by a texture to the photoelectric sensors.

2. The texture identification device according to claim 1, wherein the backlight comprises a plurality of collimated light sources.

3. The texture identification device according to claim 2, wherein an orthogonal projection of a light sensor on the backlight is within an area of a collimated light source.

4. The texture identification device according to claim 3, wherein a ratio of an orthogonal projection area of the photoelectric sensor on the backlight to an area of the collimated light source is 1/2.

5. The texture identification device according to claim 2, wherein the backlight comprises a transparent medium layer, a light emitting unit is disposed on a side of the transparent medium layer adjacent to the first substrate, and a reflection layer is disposed on a side of the transparent medium layer away from the first substrate;
wherein an arc-shaped protrusion bonded to the reflection layer is disposed on a side of the transparent medium layer facing the reflection layer, and each of the arc-shaped protrusions corresponds to one light emitting unit.

6. The texture identification device according to claim 5, wherein the light emitting unit comprises an organic light emitting diode, and a light source reflection layer is disposed on a side of the organic light emitting diode adjacent to the first substrate;
wherein light emitted by the organic light emitting diode is emitted along a side away from the first substrate.

7. The texture identification device according to claim 5, wherein the light emitting unit comprises an organic light emitting diode, and light emitted by the organic light emitting diode is emitted along a side away from the first substrate,
wherein the backlight further comprises a transparent second substrate for carrying the light emitting unit, and the second substrate is disposed on a side of the light emitting unit adjacent to the first substrate.

8. The texture identification device according to claim 2, wherein the collimated light source comprises a third substrate, a reflection layer is disposed on a side of the third substrate adjacent to the first substrate, an arc-shaped groove is disposed in the reflection layer, and a light emitting unit is disposed on a side of the arc-shaped groove adjacent to the first substrate, and
transparent material is filled between the light emitting unit and the arc-shaped groove to form a transparent medium layer.

9. The texture identification device according to claim 5, wherein a surface of the arc-shaped protrusion is a spherical cap in shape, and a spherical radius corresponding to the spherical cap is larger than a distance between the light emitting unit and a section where an apex of the spherical cap is located.

10. The texture identification device according to claim 8, wherein a surface of the arc-shaped groove is a spherical cap in shape, and a spherical radius corresponding to the spherical cap is larger than a distance between the light emitting unit and a section where an apex of the spherical cap is located.

11. The texture identification device according to claim 2, wherein the collimated light source is a monochromatic collimating light source or a white light collimating light source.

12. The texture identification device according to claim 1, wherein a light shielding unit is disposed on a side of each photoelectric sensor adjacent to the backlight.

13. An electronic device, comprising the texture identification device according to claim 1.

14. The electronic device according to claim 13, wherein the texture identification device comprises a first substrate and a backlight disposed opposite to each other, and a plurality of photoelectric sensors being disposed on the first substrate,
wherein the first substrate is a color filter substrate of the electronic device, and the plurality of photoelectric sensors is disposed on a side of the first substrate adjacent to the backlight.

15. The texture identification device according to claim 3, wherein the collimated light source comprises a third substrate, a reflection layer is disposed on a side of the third substrate adjacent to the first substrate, an arc-shaped groove is disposed in the reflection layer, and a light emitting unit is disposed on a side of the arc-shaped groove adjacent to the first substrate, and
transparent material is filled between the light emitting unit and the arc-shaped groove to form a transparent medium layer.

16. The texture identification device according to claim 4, wherein the collimated light source comprises a third substrate, a reflection layer is disposed on a side of the third substrate adjacent to the first substrate, an arc-shaped groove is disposed in the reflection layer, and a light emitting unit is disposed on a side of the arc-shaped groove adjacent to the first substrate, and
transparent material is filled between the light emitting unit and the arc-shaped groove to form a transparent medium layer.

17. The texture identification device according to claim 3, wherein the collimated light source is a monochromatic collimating light source or a white light collimating light source.

18. The texture identification device according to claim 2, wherein a light shielding unit is disposed on a side of each photoelectric sensor adjacent to the backlight.

19. The texture identification device according to claim 3, wherein a light shielding unit is disposed on a side of each photoelectric sensor adjacent to the backlight.

20. The electronic device according to claim 13, wherein the texture identification device comprises a first substrate and a backlight disposed opposite to each other, and a plurality of photoelectric sensors disposed on the first substrate,
wherein the first substrate is a color filter substrate of the electronic device, and the plurality of photoelectric sensors is disposed on a side of the first substrate away from the backlight.
